(19) United States
(12) Patent Application Publication
(10) Pub. No.: US 2010/0254583 A1
(43) Pub. Date: Oct. 7, 2010

(54) SYSTEM FOR MULTIMODALITY FUSION OF IMAGING DATA BASED ON STATISTICAL MODELS OF ANATOMY

(75) Inventors: Raymond Chan, San Diego, CA (US); Robert Manzke, Sleepyhollow, NY (US); Sandeep Dalal, Cortlandtmanor, NY (US); Francois Tournoux, PARIS (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/746,184

(22) PCT Filed: Dec. 12, 2008
(86) PCT No.: PCT/IB08/55273

§ 371 Date: Jun. 4, 2010

Related U.S. Application Data
(60) Provisional application No. 61/014,451, filed on Dec. 18, 2007.

(51) Int. Cl. G06K 9/00

(52) U.S. Cl. 382/131

(57) ABSTRACT

A ventricular epicardium registration method (60) involves three phases. The first phase (P62) is an identification of one or more anatomical features invisible within ultrasound images (41) of a ventricular epicardium of a heart (10). The second phase (P61) is a representation of the anatomical feature(s) visible within X-ray images (31) of the ventricular epicardium of the heart. The third phase (P63) is a registration of the ultrasound images (41) and the X-ray images (31) of the ventricular epicardium of the heart based on the representation of the anatomical feature(s) invisible in the ultrasound images (41) and on the identification of the anatomical feature(s) visible within the X-ray images (31). Examples of the anatomical feature(s) include, but are not limited to, a portion or an entirety of an epicardial surface (11, 12) and a coronary sinus vein (13).

Applicant claims benefit of U.S. Provisional Application Ser. No. 61/014,451, filed Dec. 18, 2007. Related applications are U.S. Provisional Application Ser. No. 61/014,455, filed Dec. 18, 2007 and U.S. Provisional Application Ser. No. 61/099,637, filed Sep. 24, 2008.

The present invention relates to methods and systems for integrating cardiac three-dimensional X-ray and ultrasound information based on anatomical features (e.g., epicardial surfaces and landmarks) within X-ray and ultrasound images of a ventricular epicardium of a heart.

Patients undergoing cardiac interventions are typically extremely fragile and are in heart failure. They are often unable to tolerate large volume contrast injections that are typical of procedures such as, for example, a ventriculography. In some of these scenarios, multimodal image-based registration requiring ventriculography cannot ethically be performed.

For example, cardiac resynchronization therapies rely on the implantation of biventricular pacer leads in the right and left heart chambers. To synchronize cardiac contraction, the left ventricular lead position is manipulated within the coronary venous anatomy to position the electrode tip within the region of greatest mechanical delay. Three-dimensional vein models derived from rotational venograms help the physician to identify promising vein branches for lead navigation, whereas dyssynchrony assessment based on three-dimensional ultrasound imaging helps identify the target location for electrode tip placement. To effectively utilize information from X-ray and ultrasound, a registration (i.e., a spatial alignment) between the X-ray and ultrasound images must be computed. One endocardial image technique for registering the X-ray and ultrasound images uses ventriculography-derived LV chamber anatomy in combination with the same chamber imaged with ultrasound for registration. However, patients undergoing cardiac resynchronization therapy are typically extremely fragile and are in heart failure, and therefore are often unable to tolerate large volume contrast agent injections that are commonly required of procedures such as ventriculography. Ventriculography-based registration of X-ray and ultrasound images is therefore problematic for CRT patients with poor cardiac and renal function.

The approach of the present invention avoids ventriculography entirely, and is more clinically-viable in situations where patients cannot tolerate large volume contrast opacification.

One form of the present invention is a ventricular epicardium registration method involving (1) a representation of one or more anatomical features invisible within ultrasound images of a ventricular epicardium of a heart, (2) an identification of the anatomical feature(s) visible within X-ray images of the ventricular epicardium of the heart, and (3) a registration of the ultrasound images and the X-ray images of the ventricular epicardium based on the representation of the anatomical feature(s) invisible within the ultrasound images and the identification of the anatomical feature(s) visible within the X-ray images. Examples of the anatomical features include, but are not limited to, a portion or an entirety of an epicardial surface and a coronary sinus vein.

A second form of the present invention is a multimodality registration system comprising a processor and memory in communication with the processor wherein the memory stores programming instructions executable by the processor to (1) represent one or more anatomical features invisible within ultrasound images of a ventricular epicardium of the heart, (2) identify the anatomical feature(s) visible within X-ray images of the ventricular epicardium of the heart, and (3) register the ultrasound images and the X-ray images of the ventricular epicardium of the heart based on the representation of the anatomical feature(s) invisible within the ultrasound images and the identification of the anatomical feature(s) visible within the X-ray images.

The foregoing form and other forms of the present invention as well as various features and advantages of the present invention will become further apparent from the following detailed description of various embodiments of the present invention read in conjunction with the accompanying drawings. The detailed description and drawings are merely illustrative of the present invention rather than limiting, the scope of the present invention being defined by the appended claims and equivalents thereof.

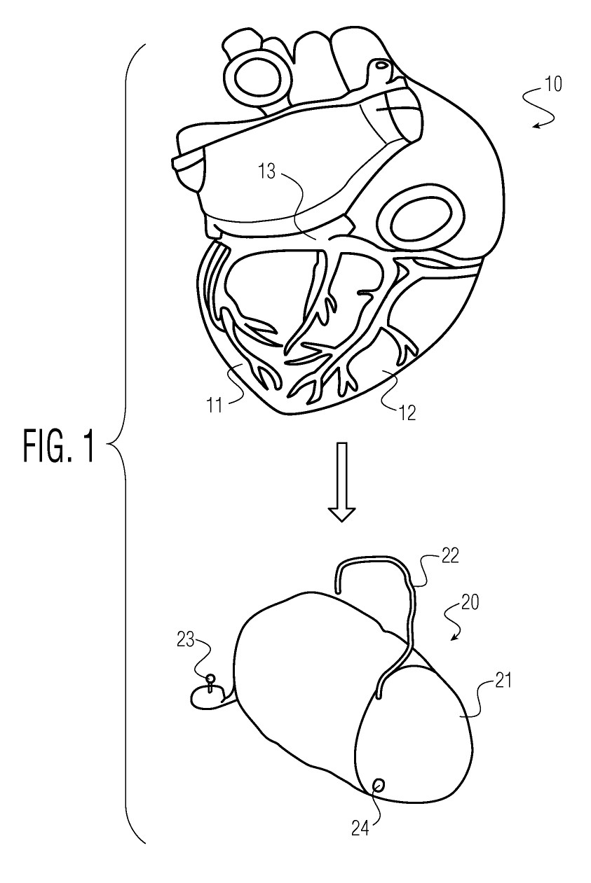

FIG. 1 illustrates an exemplary embodiment of an integrated epicardial shell/coronary venous model in accordance with present invention.

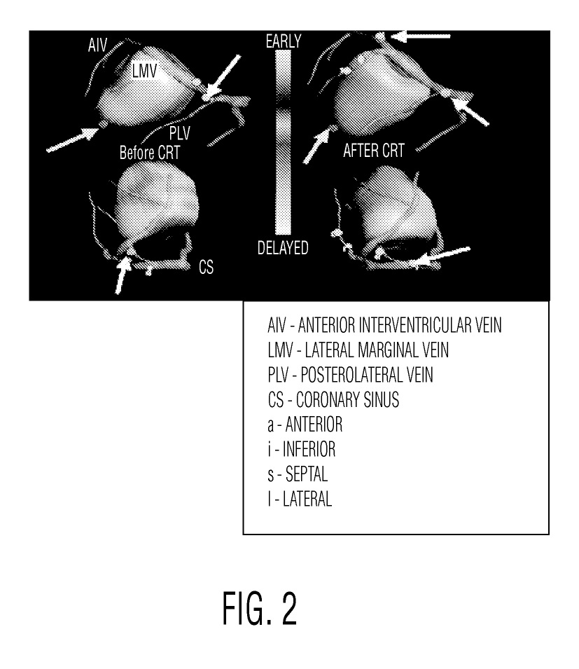

FIG. 2 illustrates an exemplary registration of X-ray and ultrasound datasets.

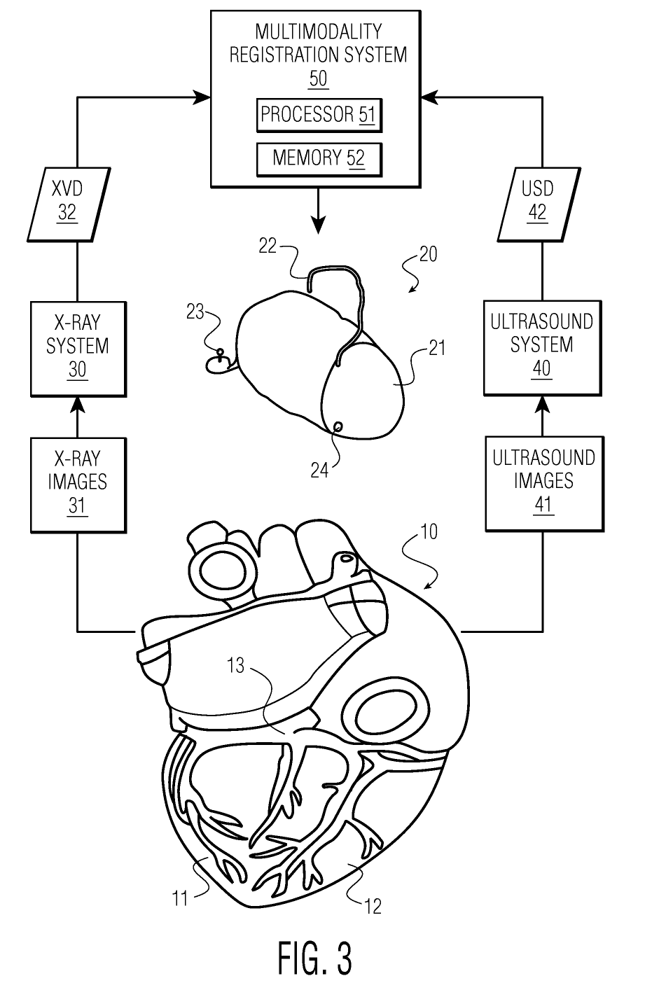

FIG. 3 illustrates a block diagram of various systems in accordance with the present invention for implementing a ventricular epicardium registration method in accordance with the present invention.

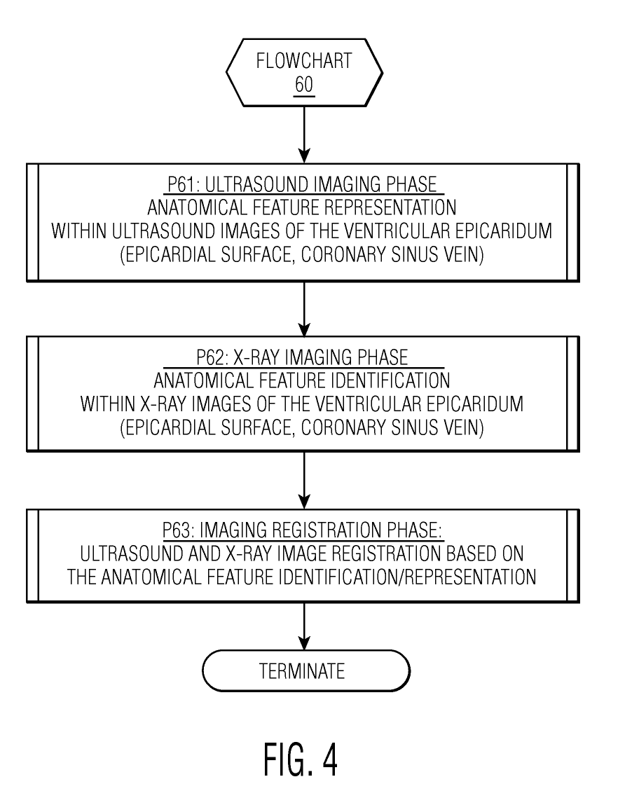

FIG. 4 illustrates a flowchart representative of an exemplary embodiment of a ventricular epicardium registration method in accordance with the present invention.

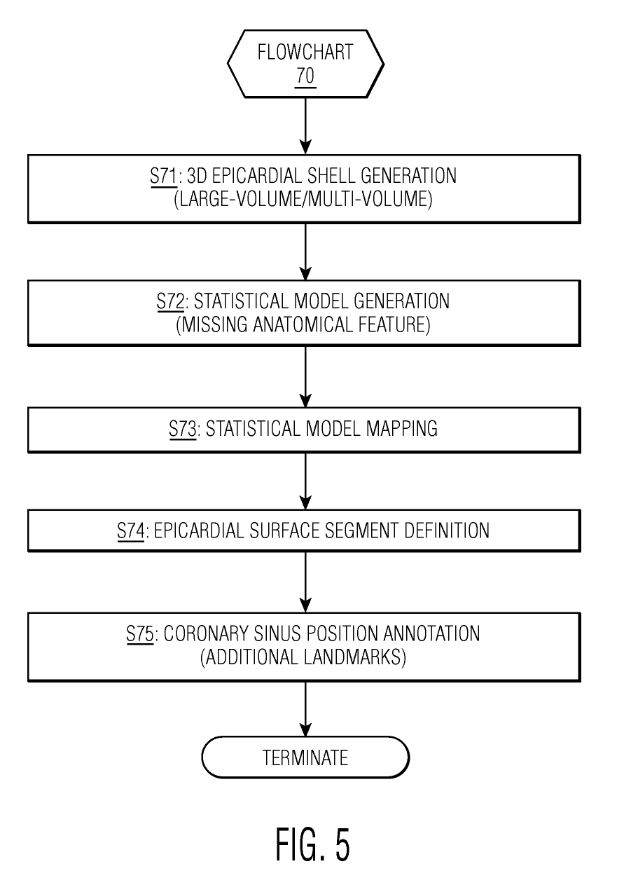

FIG. 5 illustrates a flowchart representative of an exemplary embodiment of an ultrasound imaging phase in accordance with the present invention.

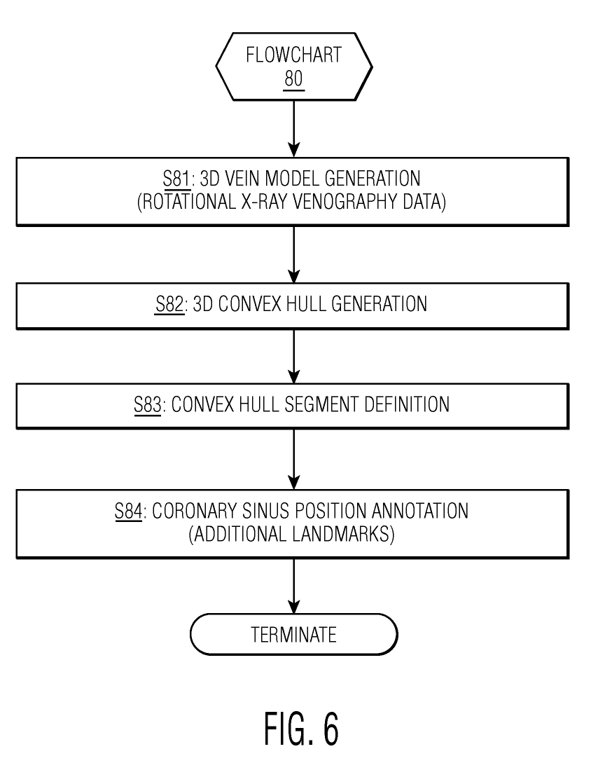

FIG. 6 illustrates a flowchart representative of an exemplary embodiment of an X-ray imaging phase in accordance with the present invention.

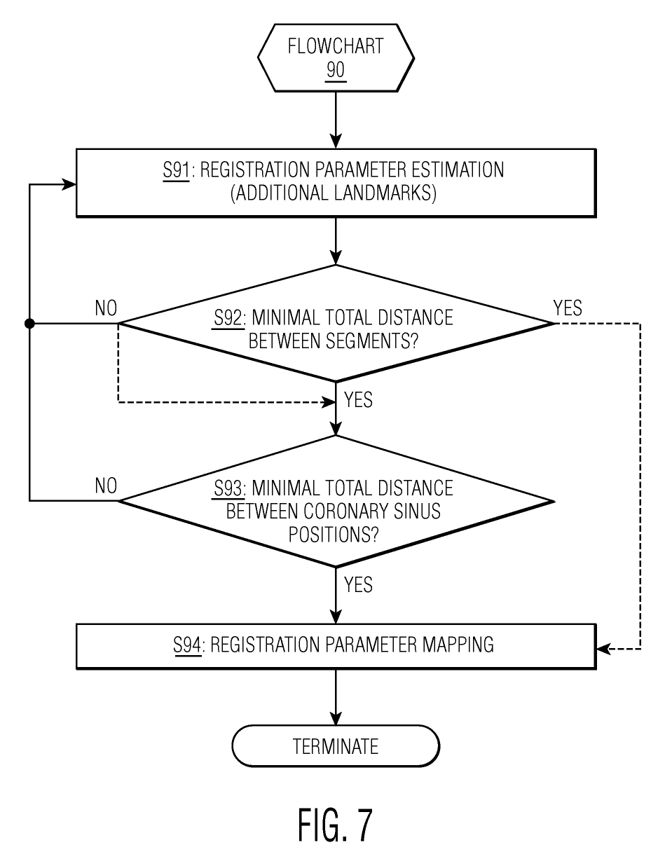

FIG. 7 illustrates a flowchart representative of an exemplary embodiment of an imaging registration phase in accordance with the present invention.

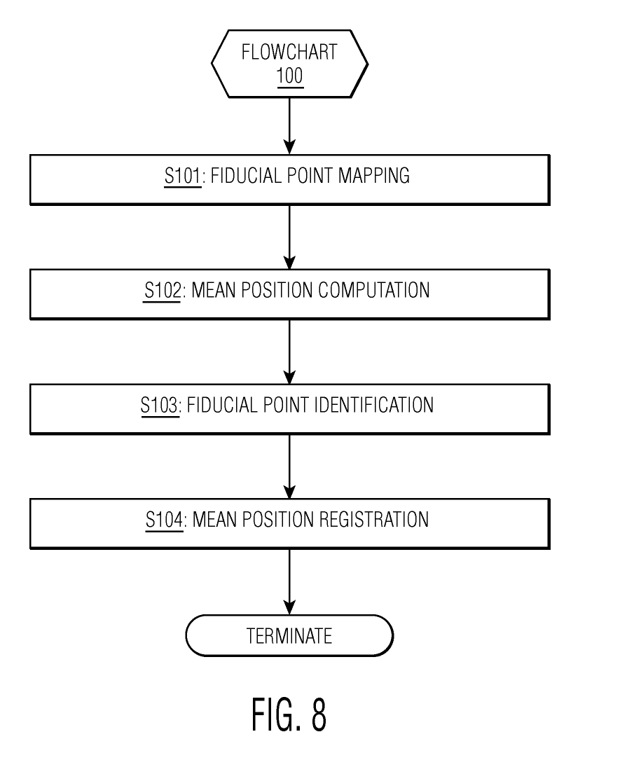

FIG. 8 illustrates a flowchart representative of an exemplary embodiment of the statistical model generation/mapping method in accordance with the present invention.

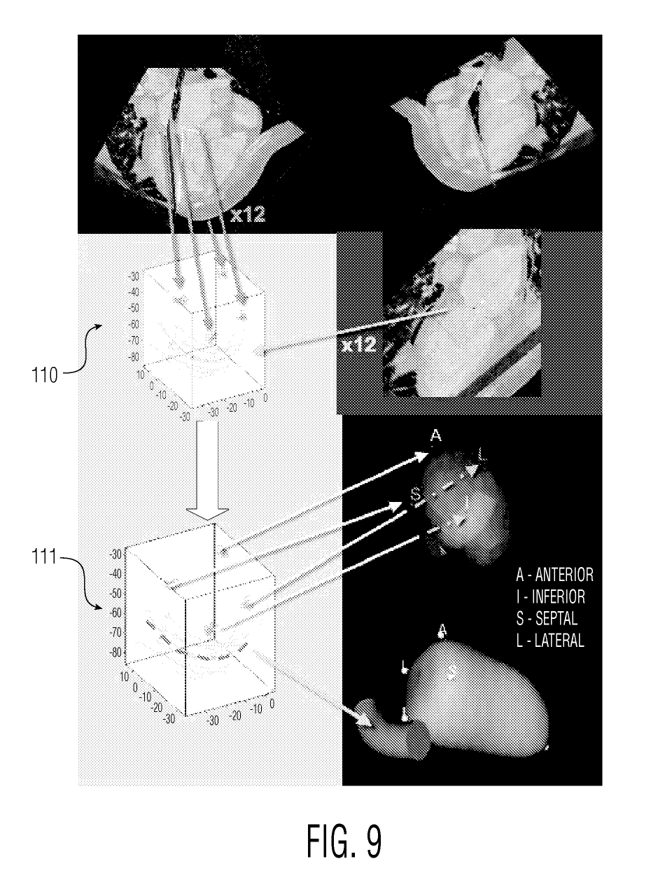

FIG. 9 illustrates an exemplary statistical model generation and mapping in accordance with the present invention.

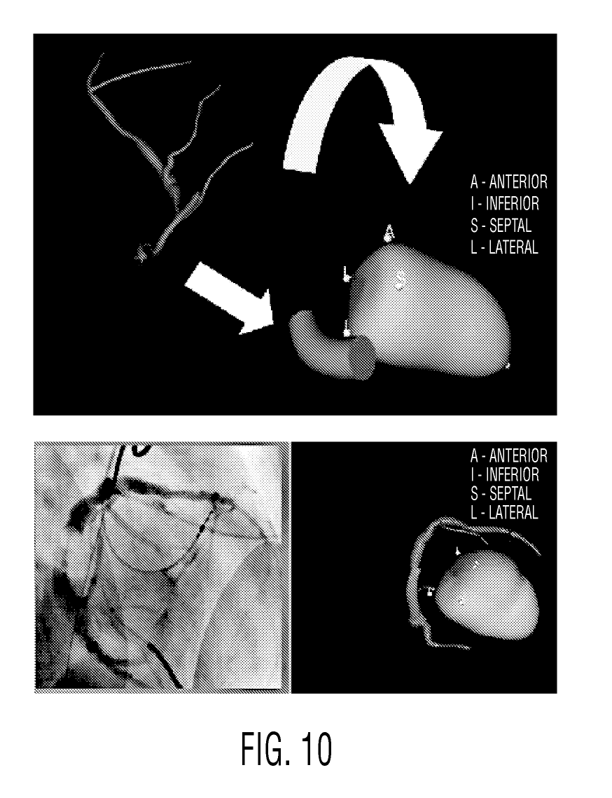

FIG. 10 illustrates an exemplary imaging registration in accordance with the present invention.

The present invention is premised on a recognition that, instead of using ventriculography for delineation of the left and/or right ventricle endocardial surfaces of a heart, ventricular epicardium may be used for location of the left and/or right ventricles of the heart. Specifically, X-ray images of the ventricular epicardium can be automatically, semi-automatically, or manually-segmented to generate a surface model onto which a position of a viable anatomical feature as visualized by the X-ray images can be annotated. Additionally, for three-dimensional ultrasound, large volume imaging can be enabled or multiple smaller volumes can be fused together to capture the shape of the entire ventricular epicardium whereby a viable anatomical feature is often enlarged and possibly visible in ultrasound imaging. If visible in the ultrasound image, a position of the anatomical feature can be automatically, semi-automatically or manually annotated onto the ultrasound images.

As stated above, the X-ray/ultrasound integration strategy of the present invention is based on registration of shared features. For example, as shown in FIG. 2, the right-ventricular (RV) lead tip location 25 and coronary venous centerline positions 26 identified from ultrasound data were transformed to match the location of the coronary vein model centerlines derived from rotational X-ray. In some cases, these features may not be easily discernable in the ultrasound data. The present invention is further premised on a derivation and use of statistical models to define three-dimensional probability maps for the locations of invisible anatomical features relative to other structures that are visible in the ultrasound data obtained. In particular, the statistical models of the anatomy of interest may be derived from a library of cardiac computer topography datasets with each statistical model being used to infer the position of the same feature in ultrasound space and then perform registration to transform the inferred feature position into the actual feature location visible in the X-ray dataset. After this process, successful fusion of ultrasound and X-ray data will have been achieved despite the absence of the actual anatomical feature used for registration in the ultrasound data.

For example, referring to FIG. 1, X-ray images of the ventricular epicardium of a heart 10 can be segmented to generate a surface model onto which a position of an epicardial surface 11 of a left ventricle of heart 10, a position of an epicardial surface 12 of a right ventricle of heart 10, and/or a position of a coronary sinus vein 13 as visualized in a posterior view of heart 10 by the X-images can be annotated. Additionally, for three-dimensional ultrasound, large volume imaging can be enabled or multiple smaller volumes can be fused together to capture the shape of the entire ventricular epicardium of heart 10 whereby the coronary sinus vein 13 is invisible in the ultrasound imaging but capable of being represented by the statistical modeling of the present invention. As such, the position of epicardial surface 11 of the left ventricle of heart 10, the position of the epicardial surface 12 of the right ventricle of heart 10, and/or the position of the coronary sinus vein 13 can automatically, semi-automatically or manually annotated onto the ultrasound images.

The end result of the present invention is a registration of the ultrasound images and the X-ray images to obtain an epicardial surface/coronary venous integration for surgical purposes, such as, for example, the integrated epicardial surface/coronary venous integration 20 shown in FIG. 1. In this example, integration 20 includes an endocardial surface 21 having a coronary sinus vein 22 spaced from surface 21 and landmarks 23 and 24 (e.g., a catheter tip) related to surface 21.

To facilitate a further understanding of the present invention, FIG. 3 illustrates an X-ray system 30, an ultrasound system 40, and new and unique multimodality registration system 50 having a processor 51 and a memory 51 storing instructions executable by processor 51 for implementing a ventricular epicardium registration method represented by a flowchart 60 shown in FIG. 4.

Referring to FIG. 3, X-ray system 30 is any X-ray system structurally configured to generate X-ray images 31 for vessel imaging heart 10, and to communicate X-ray imaging data 32 indicative of the X-ray images 31 to system 50. Complimentarily, ultrasound system 40 is any ultrasound system structurally configured to generate three-dimensional ultrasound images 41 of a full volume three-dimensional or a multiple-volume three-dimensional ultrasound imaging of heart 10, and to communicate ultrasound imaging data 42 indicative of the ultrasound images 41 to system 50. Multimodality registration system 50 is structurally configured with instructions stored in memory 52 and executable by processor 51 to process X-ray venography data 32 and ultrasound data 42 for purposes of implementing flowchart 60.

Specifically, an ultrasound imaging phase P61 of flowchart 60 involves processor 51 executing instructions for representing one or more anatomical features missing in ultrasound images 41. An X-ray imaging phase P62 of flowchart 60 involves processor 51 executing instructions for identifying one or more anatomical features shown in X-ray images 31. And, an image registration phase P63 of flowchart 60 involves processor 51 executing instructions for mapping images 31 and 41 based on the anatomical feature X-ray identification and ultrasound representation. Again, examples of anatomical features include, but are not limited to, epicardial surfaces 11 and 12 and coronary sinus vein 13 as shown in FIGS. 1 and 2.

In practice, ultrasound imaging phase P61 will typically be performed as a pre-operative event while X-ray imaging phase P62 and image registration phase P63 will be performed as operational events. Nonetheless, for purposes of the present invention, phases P61-P63 can be practiced as necessary to perform any applicable cardiovascular procedure.

A flowchart 70 shown in FIG. 5 is an exemplary embodiment of ultrasound imaging phase P61 in view of epicardial surfaces 11 and 12 and coronary sinus vein 13 serving as the anatomical features. Referring to FIG. 5, a stage S71 of flowchart 70 involves processor 51 generating a three-dimensional epicardial shell from ultrasound data 42 whereby one or more of the anatomical features may be invisible from ultrasound images 41 (i.e., the anatomical feature(2) are undetectable or incapable of being positively identified). As such, an optional stage S72 of flowchart 70 involves processor 51 generating a statistical model of the invisible anatomical feature(s) and an optional stage S73 of flowchart 70 involves processor 51 mapping the statistical model of the invisible anatomical feature(s) unto the three-dimensional epicardial shell. The statistical model generation of stage S72 is derived from a library having an X number of cardiac datasets of any type (e.g., computed topography and magnetic resonance), where X≧1. Furthermore, the statistical model mapping of stage S74 infers the position of the invisible anatomical feature(s) on the three-dimensional epicardial shell.

Upon completion of stages S72 and S73 if applicable, a stage S74 of flowchart 70 involves processor 51 defining one or more segments of the three-dimensional epicardial shell that can be used to match the convex hull segment(s) defined during stage S83 of flowchart 80, and a stage S75 of flowchart 70 involves processor 51 annotating a position of coronary sinus vein 13 on the three-dimensional epicardial shell. Again, the position of coronary sinus vein 13 includes spatial location coordinates of coronary sinus vein 13, and/or angular orientation coordinates of coronary sinus vein 13.

A flowchart 80 shown in FIG. 6 is an exemplary embodiment of an X-ray imaging phase P62 in view of epicardial surfaces 11 and 12 and coronary sinus vein 13 serving as the anatomical features. Referring to FIG. 6, a stage S81 of flowchart 80 involves processor 51 generating a three-dimensional vein model from X-ray venography data 32, and a stage S82 of flowchart 80 involves processor 51 generating a three-dimensional convex hull from the three-dimensional vein model for purposes of approximating the entire ventricular epicardium of heart 10. In view of the fact that the three-dimensional convex hull may be accurate over a limited portion of epicardial surfaces 11 and 12 (e.g., the apical hull shape may not be accurate), a stage S83 of flowchart 80 involve processor 51 defining one or more segments of the three-dimensional convex hull that accurately reflects the ventricular epicardium of heart 10 whereby these convex hull segment(s) can be used to match the ultrasound imaging of the ventricular epicardium of heart 10 as will be further explained herein. A stage S84 of flowchart 80 involves processor 51 annotating a position of coronary sinus vein 13 on the three-dimensional convex hull. The position includes spatial location coordinates of coronary sinus vein 13, and/or angular orientation coordinates of coronary sinus vein 13.

A flowchart 90 shown in FIG. 7 is an exemplary embodiment of imaging registration phase P63 in view of epicardial surfaces 11 and 12 and coronary sinus vein 13 serving as the anatomical features. Referring to FIG. 7, a stage S91 of flowchart 90 involves processor 91 estimating one or more registration parameters as necessary to thereby obtain a minimal total distance between the convex hull and epicardial surface segments during stage S92 of flowchart 90, and to thereby obtain a minimal total distance between the positions of coronary sinus vein 13 in the three-dimensional convex hull and the three-dimensional epicardial surface shell during a stage S93 of flowchart 90. Upon obtaining such minimal total distances, a stage S94 of flowchart 90 involves processor 51 mapping X-ray images 31 and ultrasound images 41 based on the minimal total distance metric of stages S92 and S93. Alternatively, stage S94 of flowchart 90 can involve processor 51 mapping X-ray images 31 and ultrasound images 41 based on the minimal total distance determination of either stage S92 or stage S93 as indicated by the dashed lines.

In further alternative embodiments, additional intrinsic landmarks (e.g., an anatomical landmark 21 shown in FIG. 2) and/or extrinsic landmarks (e.g., catheter/electrode tip 22 shown in FIG. 2) can be used for annotation and/or distance minimization between the X-ray and ultrasound images. Additionally, a total distance metric or any other appropriate goodness of fit parameter technique can be used during stages S92 and/or S93.

The result is a ventricular shell/coronary venous model integration (e.g., endocardial shell/coronary venous model integration 20 shown in FIGS. 1 and 2) for purposes of conducting applicable cardiovascular procedures, such as, for example, interventional X-ray/EP domain procedures, and particularly cardiac resynchronization therapy.

FIG. 8 illustrates a flowchart 100 to facilitate a further understanding of the statistical model generation/mapping of the present invention. Referring to FIG. 8, a stage S101 of flowchart 100 involves processor 51 mapping one or more fiducial points shown in the ultrasound images 41 in the statistical model, and a stage 5102 of flowchart 100 involves processor 51 computing a mean position of the invisible anatomical feature.

For example, FIG. 9 illustrates a statistical model generation 100 based on a delineation of a proximal 3 cm of the coronary veinous centerline relative to four (4) mitral valve fiducial points visible in cardiac computer tomography and ultrasound. The three-dimensional locations of four (4) mitral valve fiducial points (112 in lower left plot) are determined from multiplanar reformatted slices of twelve (12) cardiac computer tomography volumes. The centerline location of the proximal 3 cm of the coronary veins is also defined 113 for each patient. These markers are all mapped into a common reference space and the mean position of the three-dimensional coronary venous centerline 114 is computed. The centerline 114 represents the inferred proximal vein centerline location relative to the mitral valve fiducials which are readily identifiable in the three-dimensional ultrasound datasets.

Referring again to FIG. 8, upon completion of stage S101 and S102, a stage S103 involves processor 51 identifying the fiducial point(s) in the ultrasound dataset 42, and a stage 5104 of flowchart 100 involves processor 51 registering the computed mean position of the invisible anatomical feature within the ultrasound dataset 42.

For example, referring to FIG. 9, a statistical mode mapping 101 uses the same mitral valve fiducials measured in cardiac computer tomography volumes and easily identifiable in ultrasound volume data 42 whereby the mitral valve fiducials are used to register the left ventricular shell from cardiac echo with the statistical model of the proximal coronary vein. Again, the coronary vein measurements from the 12 patients were averaged to build the model shown. The vein model centerline (dashed green line in left plot, red curvilinear segment in three-dimensional rendering on the right) is the mean three-dimensional position over 12 patients whereas the model diameter represents one standard deviation of the centerline position at each segment location. FIG. 10 illustrates a registration of ultrasound and X-ray spaces based on spatial transformation of the proximal vein model in ultrasound space into the corresponding segment of the coronary vein present in X-ray space with the final result showing rotational X-ray projection on the bottom left and corresponding fused LV shell (from 3DUS) and vein model (from rotational X-ray) on the bottom right.

Referring to FIG. 1-10, those having ordinary skill in the art will appreciate the various benefits of the present invention including, but not limited to, a reduction or an elimination of external tracking systems that results in low clinical overhead and allows/requires very small contrast boluses. Additionally, in practice, various techniques for the annotation, segmentation and registration requirements of the present invention may be used in dependence upon the specific cardiac procedure being performed and the specific equipment being used to perform the cardiac procedure. Preferably, (1) segmentation of the three-dimensional convex hull is derived from Elco Oost, et. al, “Automated contour detection in X-ray left ventricular angiograms using multiview active appearance models and dynamic programming”, IEEE Trans Med Imaging September 2006, (2) segmentation of the three-dimensional epicardial surface shell is derived from Alison Noble, et. al, “Ultrasound image segmentation: a survey”, IEEE Trans Med Imaging, August 2006, and (3) registration of the X-ray and ultrasound images is derived from Audette et al, Medical Image Analysis, 2000.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A ventricular epicardium registration method (60), comprising:
(P61) a representation of at least one anatomical feature invisible within ultrasound images (41) of the ventricular epicardium of the heart (10); and
(P62) an identification of the at least one anatomical feature visible within X-ray images (31) of a ventricular epicardium of a heart (10);
(P63) a registration of the X-ray images (31) and the ultrasound images (41) of the ventricular epicardium of the heart (10) based on the representation of the at least one anatomical feature invisible within the ultrasound images (41) and the identification of the at least one anatomical feature visible within the X-ray images (31).

2. The ventricular epicardium registration method (60) of claim 1, wherein the at least one anatomical feature includes at least one of an epicardial surface (11, 12) and a coronary sinus vein (13) of the heart (10).

3. The ventricular epicardium registration method (60) of claim 1, wherein (P61) the representation of the at least one anatomical feature invisible within ultrasound images (41) of the ventricular epicardium of the heart (10) includes:
(S72) a generation of a statistical model of a first anatomical feature derived from a library of at least cardiac dataset.

4. The ventricular epicardium registration method (60) of claim 3, wherein (P61) the representation of the at least one anatomical feature invisible within ultrasound images (41) of the ventricular epicardium of the heart (10) further includes:
(S73) a mapping of the statistical model of the first anatomical feature within the ultrasound images (41).

5. The ventricular epicardium registration method (60) of claim 3, wherein the library of at least cardiac dataset includes at least one of a computer tomography dataset and a magnetic resonance dataset.

6. The ventricular epicardium registration method (60) of claim 1, wherein (P61) the representation of the at least one anatomical feature invisible within ultrasound images (41) of the ventricular epicardium of the heart (10) includes:
(S101) a mapping at least one fiducial point identifiable within the ultrasound images (41) and a library of at least one cardiac dataset into a common reference space.

7. The ventricular epicardium registration method (60) of claim 6, wherein (P61) the representation of the at least one anatomical feature invisible within ultrasound images (41) of the ventricular epicardium of the heart (10) further includes:
(S102) a computation of a mean position of a first anatomical feature in the common reference space relative to the at least one fiducial point.

8. The ventricular epicardium registration method (60) of claim 7, wherein (P61) the representation of the at least one anatomical feature invisible within ultrasound images (41) of the ventricular epicardium of the heart (10) further includes:
(S73) an identification of the first anatomical feature within the ultrasound images (41).

9. The ventricular epicardium registration method (60) of claim 8, wherein (S73) the statistical model mapping of the first anatomical feature within the ultrasound images (41) further includes:
(S103) a registration of the mean position of the first anatomical feature invisible within the ultrasound images (41).

10. The ventricular epicardium registration method (60) of claim 6, wherein the library of at least cardiac dataset includes at least one of a computer tomography dataset and a magnetic resonance dataset.

11. A multimodality registration system (50), comprising:
a processor (51); and
a memory (52) in communication with the processor (51), wherein the memory (52) stores programming instructions executable by the processor (51) to:
(P61) represent at least one anatomical feature invisible within ultrasound images (41) of the ventricular epicardium of the heart (10); and
(P62) identify the at least one anatomical feature visible within X-ray images (31) of a ventricular epicardium;
(P63) register the X-ray images (31) and the ultrasound images (41) of the ventricular epicardium based on the representation of the at least one anatomical feature invisible within the ultrasound images (41) and on the identification of the at least one anatomical feature visible within the X-ray images (31).

12. The ventricular epicardium registration system (50) of claim 11, wherein the at least one anatomical feature includes at least one of an epicardial surface (11, 12) and a coronary sinus vein (13) of the heart (10).

13. The ventricular epicardium registration system (50) of claim 11, wherein (P61) the representation of the at least one anatomical feature invisible within ultrasound images (41) of the ventricular epicardium of the heart (10) includes:
(S72) a generation of a statistical model of a first anatomical feature derived from a library of at least cardiac dataset.

14. The ventricular epicardium registration system (50) of claim 13, wherein (P61) the representation of the at least one anatomical feature invisible within ultrasound images (41) of the ventricular epicardium of the heart (10) further includes:
(S73) a mapping of the statistical model of the first anatomical feature within the ultrasound images (41).

15. The ventricular epicardium registration system (50) of claim 13, wherein the library of at least cardiac dataset includes at least one of a computer tomography dataset and a magnetic resonance dataset.

16. The ventricular epicardium registration system (50) of claim 11, wherein (P61) the representation of the at least one anatomical feature invisible within ultrasound images (41) of the ventricular epicardium of the heart (10) includes:
(S101) a mapping at least one fiducial point identifiable within the ultrasound images (41) and a library of at least one cardiac dataset into a common reference space.

17. The ventricular epicardium registration system (50) of claim 16, wherein (P61) the representation of the at least one anatomical feature invisible within ultrasound images (41) of the ventricular epicardium of the heart (10) further includes:
(S102) a computation of a mean position of a first anatomical feature in the common reference space relative to the at least one fiducial point.

18. The ventricular epicardium registration system (50) of claim 17, wherein (P61) the representation of the at least one anatomical feature invisible within ultrasound images (41) of the ventricular epicardium of the heart (10) further includes:
(S73) a mapping of a statistical model of the first anatomical feature within the ultrasound images (41).

19. The ventricular epicardium registration system (50) of claim 18, wherein (S73) the statistical model mapping of the first anatomical feature within the ultrasound images (41) further includes:
(S103) a registration of the mean position of the first anatomical feature invisible within the ultrasound images (41).

20. The ventricular epicardium registration system (50) of claim 16, wherein the library of at least cardiac dataset includes at least one of a computer tomography dataset and a magnetic resonance dataset.
